(19) United States
(12) Patent Application Publication
(10) Pub. No.: US 2018/0096494 A1
(43) Pub. Date: Apr. 5, 2018

(54) VIEW-OPTIMIZED LIGHT FIELD IMAGE AND VIDEO STREAMING

(71) Applicant: VISBIT INC., Sunnyvale, CA (US)

(72) Inventor: Changyin ZHOU, San Jose, CA (US)

(21) Appl. No.: 15/720,395

(22) Filed: Sep. 29, 2017

Related U.S. Application Data
(60) Provisional application No. 62/402,854, filed on Sep. 30, 2016.

(51) Int. Cl. G06T 7/80; G06T 19/00

(52) U.S. Cl. CPC G06T 7/85; G06T 19/003; G06T 19/006; G06T 2207/10076; G06T 2207/20064; G06T 2207/10052; G06T 2207/20056

(57) ABSTRACT

The present disclosure relates to methods and systems for providing virtual reality video content. An example method includes capturing light field image data with a plurality of cameras. The light field image data includes a plurality of sample data points. The method includes determining a viewpoint position and a viewpoint pose. The method further includes determining a nearest neighbor set based on the sample data points, the viewpoint position, and the viewpoint pose. The method also includes interpolating within the nearest neighbor set so as to form a set of resampled data points. The method yet further includes rendering a 360° image from the resampled data points. The 360° image includes a representation of the light field based on the viewpoint position and the viewpoint pose.

### CROSS-REFERENCE TO RELATED APPLICATION

The present application claims the benefit of U.S. Patent Application No. 62/402,854, filed Sep. 30, 2016, the content of which is herewith incorporated by reference.

### BACKGROUND

A light field is a vector function that describes an amount of light flowing in every direction through every point in space. For a given spatial volume, a light field can be represented by a four-dimensional (4D) function. Using light field vector information, one may render views of the light from various arbitrary positions and orientations within the spatial volume.

Memory size requirements for 4D light field data are often much larger than for a two-dimensional (2D) photo, which poses challenges to storage, compression, and transmission of such light field information.

### SUMMARY

Systems and methods disclosed herein relate to a view-optimized streaming solution that may stream light field images and videos more efficiently than conventional systems. Namely, example embodiments may stream a portion of the light field that a user is currently looking at (as opposed to the entire light field). Furthermore, methods and systems described herein may reduce the latency to stream and render another portion when the user changes viewing orientation.

In an aspect, a system is provided. The system includes a plurality of cameras disposed so as to capture images of a light field. The system also includes a controller having at least one processor and a memory. The at least one processor executes instructions stored in the memory so as to carry out operations. The operations include causing the plurality of cameras to capture light field image data. The light field image data includes a plurality of sample data points. The operations include determining a viewpoint position and a viewpoint pose and determining a nearest neighbor set based on the sample data points, the viewpoint position, and the viewpoint pose. The operations further include interpolating within the nearest neighbor set so as to form a set of resampled data points. The operations yet further include rendering a 360° image from the resampled data points. The 360° image includes a representation of the light field based on the viewpoint position and the viewpoint pose.

In a further aspect, a method is provided. The method includes capturing light field image data with a plurality of cameras. The light field image data includes a plurality of sample data points. The method also includes determining a viewpoint position and a viewpoint pose and determining a nearest neighbor set based on the sample data points, the viewpoint position, and the viewpoint pose. The method yet further includes interpolating within the nearest neighbor set so as to form a set of resampled data points. The method includes rendering a 360° image from the resampled data points. The 360° image includes a representation of the light field based on the viewpoint position and the viewpoint pose.

In another aspect, a system is provided. The system includes various means for carrying out the operations of the other respective aspects described herein.

These as well as other embodiments, aspects, advantages, and alternatives will become apparent to those of ordinary skill in the art by reading the following detailed description, with reference where appropriate to the accompanying drawings. Further, it should be understood that this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE FIGURES

FIG. 1 illustrates a parameterization of a 360° light field, according to an example embodiment.

FIG. 2 illustrates a system, according to an example embodiment.

FIG. 3 illustrates several light field viewing scenarios, according to example embodiments.

FIG. 4 illustrates several light field viewing scenarios, according to an example embodiment.

FIG. 5 illustrates several light field viewing scenarios, according to an example embodiment.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features. Other embodiments can be utilized, and other changes can be made, without departing from the scope of the subject matter presented herein.

Thus, the example embodiments described herein are not meant to be limiting. Aspects of the present disclosure, as generally described herein, and illustrated in the figures, can be arranged, substituted, combined, separated, and designed in a wide variety of different configurations, all of which are contemplated herein.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

### I. 360° Light Field Representation, Sampling, and Resampling

A. 360° Light Field Representation

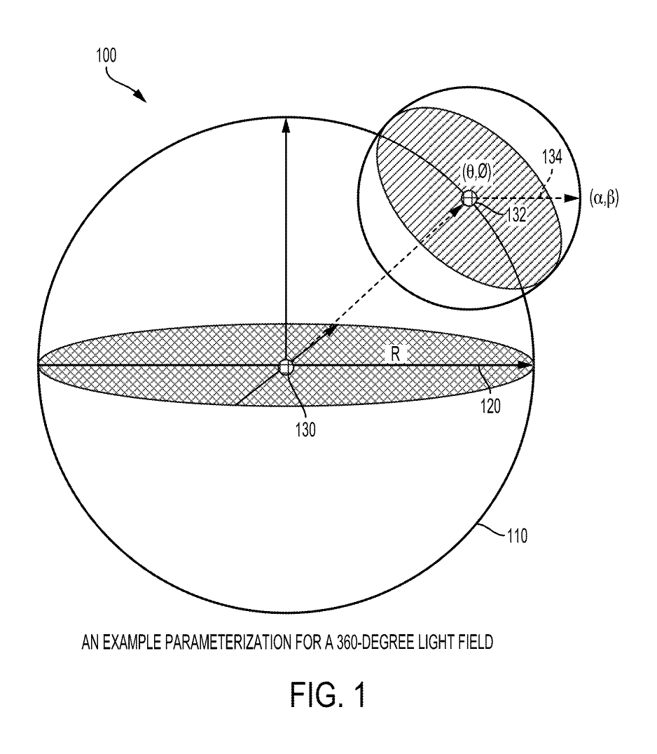

FIG. 1 illustrates a parameterization of a 360° light field 100, according to an example embodiment. A 4D light field can be parameterized in a variety of ways. Herein, a 360° light field 100 may be parameterized as L(θ, Φ, α, β), where (θ, Φ) is a coordinate on a sphere 110 having a radius 120 equal to R. (α, β) is defined as a coordinate on a semi-sphere that is centered at (θ, Φ). That is, in an example embodiment, a viewpoint location 132 within a light field 100 may be described as a point along a sphere 100 with a radius R away from an origin 130. Furthermore, a viewpoint pose may be described as a ray 134 that originates from the viewpoint location 132 and points toward (α, β), which is a point on the semi-sphere with origin at (θ, Φ). In some embodiments, θ is a longitudinal coordinate with the range [0, 360°], Φ is a latitudinal coordinate with the range [−90 degrees, 90+], α is a longitudinal coordinate in the semi-sphere, with the range [0, 360°], and β is a latitudinal coordinate in the semi-sphere with the range [0, 90°]. As such, in an example embodiment, a 360° light field may be represented by L(θ, Φ, α, β) and the radius R.

B. 360° Light Field Capturing or Sampling

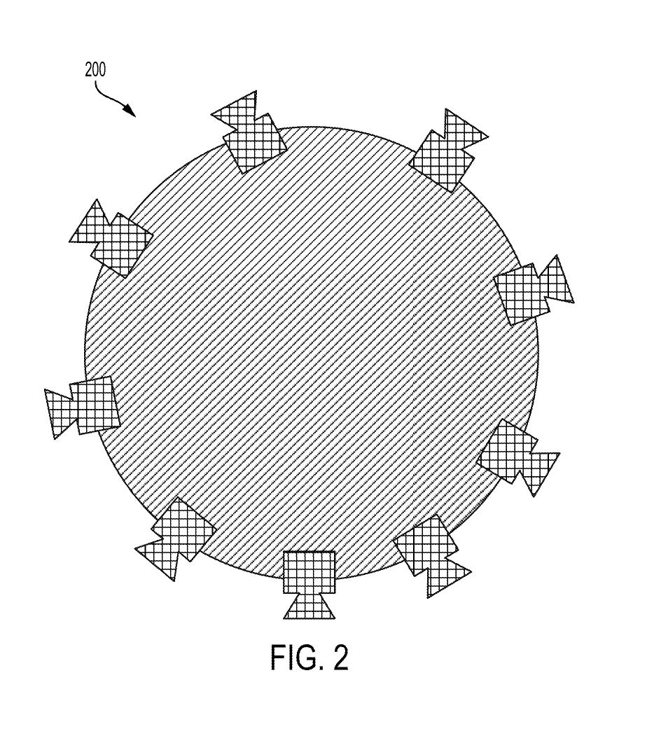

FIG. 2 illustrates a system 200, according to an example embodiment. As illustrated in FIG. 2, a 360° light field may be captured by an array and/or a plurality of cameras mounted or otherwise disposed along a surface of a sphere, each facing outward. That is, each camera of the plurality of cameras could be arranged facing outwards from the sphere. The cameras may include video image capture devices and/or still image capture devices. The position of each camera on the sphere may be described by a respective value of (θ, Φ). Furthermore, for each camera, captured images may be represented by a respective value of (α, β), indicating the viewpoint pose of the respective camera.

Optionally, instead of using a (θ, Φ) coordinate along the sphere, a position index, i, may be used to indicate camera positions. In such a scenario, the sampled light field can be represented by: (i, α, β) and a (θ, Φ) value may be obtained (e.g., via a lookup table) for each camera based on the value of i.

C. 360° Light Field Resampling

The system 200 may provide image information that may be combined to form a light field of limited sampling points F(i, α, β), where i is an integer=1 , . . . , k; α=(1, 2 , . . . , integer M)/M×360°; (β=(1, 2 , . . . , integer N)/N×180°−90°. In such a scenario, to render a 360° image from an arbitrary viewpoint location (x₀, y₀) and an arbitrary viewpoint pose (a, b), the image information may be resampled.

For example, consider a given arbitrary viewpoint location and viewpoint pose given by ray (x₀, y₀, a, b) (e.g., ray 134 in FIG. 1). Resampling based on the arbitrary ray 134 may be performed by first finding the w nearest rays in the sampled light field F(i, α, β). Subsequently, the value of (x₀, y₀, a, b), and the rendered 360° image, may be estimated from these nearest rays based on interpolation. As possible examples, linear interpolation, polynomial interpolation, spline interpolation, cubic interpolation, or other interpolation methods are possible and contemplated herein.

### II. View-Optimized Light Field Streaming: Tiling

A 360° light field image or video may include huge amounts of environmental information. However in virtual reality (VR) applications, a user may only look at a limited field of view for a short amount of time. For example, a user may explore the environment by adjusting a field of view and/or adjusting a viewing position. In example embodiments, the viewing position of the user and/or a head-mountable VR device could be determined based on information received from a sensor, such as an accelerometer, an inertial measurement unit, or another type of positioning or pose-determining system. In other words, the sensor may be configured to provide information indicative of a current viewpoint position and/or a current viewpoint pose of the head-mountable VR device or other information indicative of the user's viewing position.

In an example embodiment, methods and systems may stream a high resolution representation (e.g., high resolution image information) related to a visible portion of the light field, which may be based on the user's viewing position and/or field of view. That is, methods herein may stream only the visible portion of light field to the user at high resolution, which may greatly reduce the bandwidth required to stream light field data. Furthermore, when a user moves viewpoints (e.g., shifts to a different viewpoint location), the present disclosure may provide a reduced time to stream new data as compared to conventional methods, which may significantly improve a user experience.

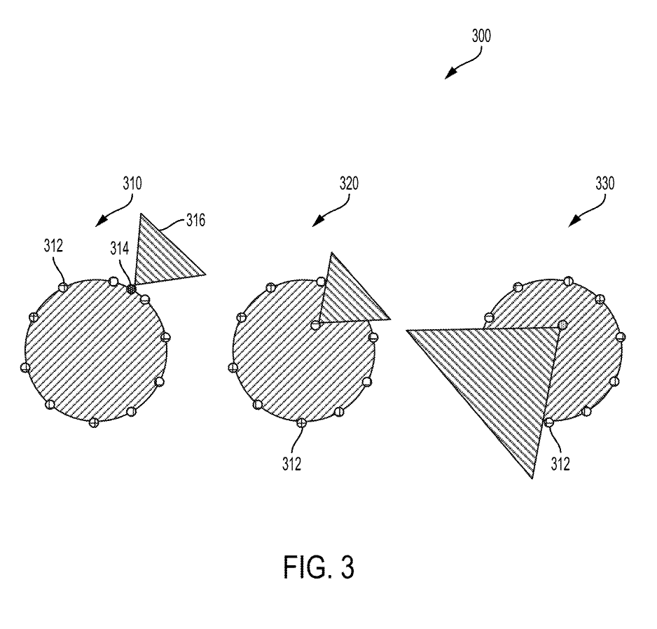

FIG. 3 illustrates several light field viewing scenarios 300, according to example embodiments.

In one embodiment, the light field may be partitioned or divided into a plurality of tiles. For a given user viewpoint, only a small number of tiles are needed to render the frame. That is, only a small subset of tiles, corresponding to the viewpoint location and viewpoint pose of the user, are needed to render a 360° image frame. For example, in scenario 310, the camera positions 312 may provide image data to form a sampled light field. Furthermore, viewpoint location 314 may represent a desired view position to simulate in a VR environment. A field of view 316 may be determined based on a viewpoint pose of the user. In such a scenario, only a portion of light field data captured by the plurality of cameras is required to render what the user may desire to view in VR.

When the user turns head to another direction as in scenario 330, the method may provide (e.g., stream to the client device) another portion of light field data for rendering. However, in virtual all cases, the portion of light field data needed for rendering will be much less than the entire amount light field information.

A. Light Field Tiling

Consider a light field L(θ, Φ, α, β) that may be discretized (e.g., pixelated in 4D) in each of four dimensions, for example, 20×20×1200×1200. In one embodiment, one may divide the light field into a number of four-dimensional (4D) tiles, each of which include a plurality of discrete “pixels”. As an example, each tile may include 4×4×400×400 light field pixels. In such a scenario, there may be (5×5×3×3) tiles defined. Each tile may include light field information about a relatively small area of viewpoint and a relatively small field of view.

Additionally or alternatively, consider a light field L(i, α, β) which may be discretized in three dimensions (one dimension for each light field variable). For example, the light field may be partitioned into 100×1200×1200 light field pixels. In one embodiment, one may divide the light field into a number of three-dimensional (3D) tiles, each of which may include a plurality of light field pixels. For example, each tile may include 4×400×400 light field pixels. In such a scenario, there may be (25×4×4) tiles defined.

Consider a light field L(θ, Φ, α, β, t). In addition to the 4D tiling described above, methods and systems herein may be configured to divide the light field image information into small duration clips (e.g., t₀ to t₁, t₁ to t₂, t₂ to t₃, etc.).

In another embodiment, the light field image information may be partitioned based on a frequency domain. That is, the light field image information may be converted into the frequency domain via a Fourier transform or a Wavelet transform. The Fourier transform of the light field image information may provide information about the image based on a spatial frequency of image features. Subsequently, the transformed image information may be partitioned (e.g., tiled) in the frequency domain. Additionally or alternatively, in some embodiments, the light field tiles may include similar ranges of spatial frequency information. Other tiling methods are possible and contemplated herein.

B. Find Neighbor Tiles for Rendering

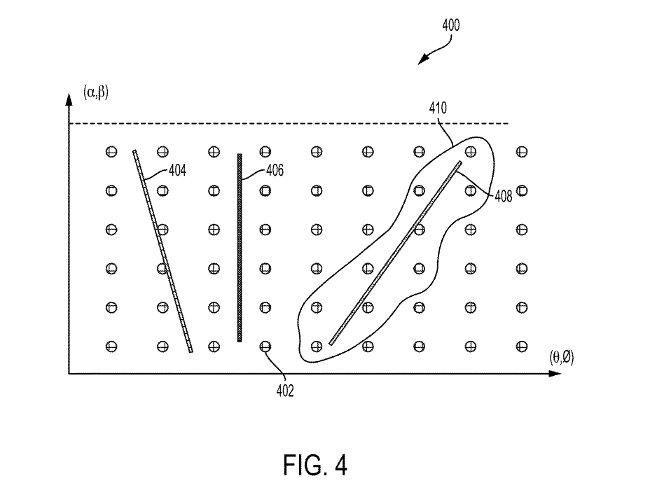

FIG. 4 illustrates several light field viewing scenarios 400, according to an example embodiment. At a given moment in time, a user may view a single rendered 2D “slice” of the 4D light field information. For simplicity, we show a 2D version of light field in FIG. 4, where the x-axis represents (θ, Φ), and y-axis represents (α, β). As such, the views as shown in FIG. 4 will be represented as line segments in this 2D light field diagram. Here, the cameras 402 may capture the image samples that make up the light field 400. In such a visual representation, line 406 may correspond to scenario 310 in FIG. 3, line 404 may correspond to scenario 320, and line 408 may correspond to scenario 330.

For efficient streaming, one may want to minimize the number of tiles that are required to cover each 2D slice. For example, to render the view as shown in scenario 330 of FIG. 3 (right), a method or system may stream image information relating to the samples surrounded by the shape 410 in FIG. 4. Finding surrounding samples from a 2D slice in a 4D light field may be provided by a nearest neighbor search.

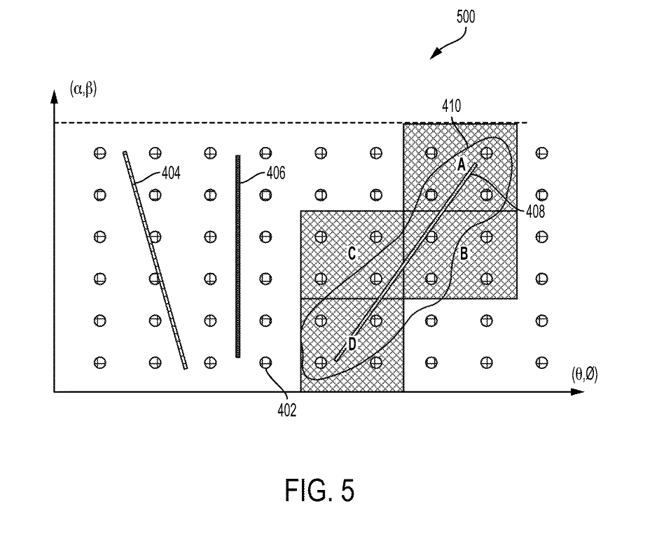

FIG. 5 illustrates several light field viewing scenarios 500, according to an example embodiment. As described herein the light field information may be tiled into a plurality of discrete portions of the light field. In such a scenario, only a small number of the plurality of tiles may be needed for rendering a given viewpoint location and viewpoint pose (e.g., line 408). For example, for line 408, only tiles A, B, C, and D need to be streamed or otherwise provided to a client device to render the desired view.

C. Low-Latency Light Field Streaming

While viewing and/or interacting with VR content, a user may adjust a viewpoint location (change θ, Φ) and/or a viewpoint pose (change α, β). When either change happens, the tiles needed for image rendering may change. For example, again in reference to FIG. 5, the necessary rendering information may shift from tiles A/B/C/D to A/B/C/E. In such a scenario, only one new tile needs to be streamed in order to provide rendered images from the desired viewpoint location and viewpoint pose.

In an example embodiment, a system or method may include pre-fetching neighbor tiles (like tile E) prior to (e.g., before) head motion. In some embodiments, motion prediction may be performed so that the image data is already available for rendering when a user's head moves. Motion prediction may be based on prior user movements (e.g., moving between two viewpoint poses while watching a virtual tennis match). Additionally or alternatively, motion prediction may be based on the VR content provided to the user. For example, if, while viewing a VR movie, a protagonist is not fully within the user's field of view, a motion prediction method or system may predict that the user may move his or her head so as to bring the protagonist more fully into the field of view. In such a scenario, light field tiles that relate to image information predicted to be needed (e.g., due to predicted motion such as a user head movement) may be pre-fetched (and possibly pre-rendered) so as to be ready for display to the user immediately upon the predicted head movement.

In an example embodiment, light field tiles that are within a user's field of view may be termed viewable light field tiles while light field tiles that are outside a user's field of view could be termed unviewable light field tiles. Furthermore, light field tiles that are needed due to predicted user movement may be termed predicted viewable light field tiles. In such a scenario, a low resolution version of the predicted viewable light field tiles could be streamed and/or presented to the user while a high resolution version of the predicted viewable light field tiles are fetched in parallel and presented upon availability.

In another embodiment, a low resolution representation of the light field may be persistently available. That is, the low resolution representation of the light field, or a portion thereof, may be always available to the user. In such a scenario, when head motion occurs, a low-resolution frame may be rendered with almost no latency. In parallel (e.g., at the same time), a high-resolution representation of the light field may be fetched from a media server. As such, the high-resolution may be rendered with a finite latency. In such scenarios, users may be more tolerant to low-res-to-high-res latency compared to waiting for a blank screen to display high-resolution images. That is, in a “worst” case scenario, a user will always be able to view a low resolution image with low latency, with some delay for high resolution content.

To perform light field tiling, similar techniques and methods may be applied as those described in the U.S. provisional patent application 62/320,451 “View-Aware 360° VR video streaming.”

### III. View-Optimized Light Field Streaming: Projection Solution

A. View-Optimized Light Field Projection

In an example embodiment, a number of views may be pre-rendered before streaming. Each view may be pre-rendered from high-resolution image data for the currently visible portions of the respective view. Furthermore, some views may be rendered based on lower resolution image information in the cases where the respective view corresponds to a portion of the light field that is not near the visible portion.

In some embodiments, a number of viewpoints may be selected within the view sphere. For each viewpoint, a number of directions (α, β) may be selected. For an arbitrary view from point (θ, Φ) to direction (α, β), a small light field, L′ may be pre-sampled from the original sampled light field, L. In some embodiments, L may be pre-sampled with higher sample density for areas near the current viewpoint location (θ, Φ) and viewpoint pose (α, β). This may include a scaled amount of image information that increases in density near the viewpoint location and viewpoint pose. In other words, the plurality of sample data points may include a variable sample density based at least on the viewpoint position and the viewpoint pose.

In one embodiment, L(i, α₀, β₀) of radius r may represent a current viewpoint location and viewpoint pose. In such a scenario, originally sampled L may be resampled as follows:
1. For each i:
   a. Look up the view position (θ₀, Φ₀) from index i.
   b. Represent every frame captured by a camera (as shown in FIG. 2) by (R, θ, Φ, α, β), and compute its distance, d, to (r, θ₀, Φ₀, α₀, β₀)
   c. Compute a resize scale using d. If d=0, then scale =1; if d=diameter of the whole light field, then scale=0 or another small number; if d is in between, then linearly assign a number between 0 and 1.
   d. Apply the scale to the frame captured by the camera.
   e. Save a distorted small light field by putting all scaled frames together.

### B. View-Optimized Light Field Streaming

In VR, a user may change/adjust a viewpoint pose (e.g., change alpha and beta), or move viewpoint location (e.g., change θ, Φ). When the change is larger than a certain threshold amount (for example, >15° orientation/pose change or >1 cm location change), a method or system described herein may request a new portion of the light field information. For example, a rendered image may be provided by a first portion of the light field. However, if a user moves his or her head by more than the threshold amount, a second portion of the light field may be responsively requested/streamed/rendered.

In one embodiment, the process goes as:

1. Let (r₀, θ₀, Φ₀, α₀, β₀) be the current view of VR user, which corresponds to light field L₀.

2. When head motion is detected, compare the new view to (r₀, θ₀, Φ₀, α₀, β₀), if the distance is larger than threshold T, then compute a tentative new view as (r₁, θ₁, Φ₁, α₁, β₁).

3. Continue to stream the old light field (r₀, θ₀, Φ₀, α₀, β₀) from media server until the buffer is over a certain size, and then switch streaming source to the new light field of (r₁, θ₁, Φ₁, α₁, β₁).

4. Before new data from the new view arrives, frames from the previous view may be rendered and displayed to the user at least until the new view data is ready for user presentation.

5. Once new data from the new view arrives, go to Step 1.

In some cases, switching from View 1 to View 2 may relate to a special type of track switching as in typical adaptive bitrate (ABR) streaming. As such, the same technology in ABR can be applied here.

### IV. Large Field of View Light Field Image or Video Streaming

Although embodiments herein relate to 360° light field image or video streaming, the same technology may also be applied to other large field of view light field data as well. That is, methods and systems described herein may relate to light field information with 180° or 300° maximum field of view. Generally, the methods and systems described herein may relate to providing rendered representations of any type of light field information from arbitrary viewpoint locations and viewpoint poses.

It is understood that the systems and methods described herein may be applied to augmented reality (AR) scenarios as well as VR scenarios. That is, the video images presently described may be superimposed over a live direct or indirect view of a physical, real-world environment. Furthermore, although some embodiments herein describe 360° virtual reality video content, delivery, and/or services, it is understood that video content corresponding to smaller portions of a viewing sphere may be used within the context of the present disclosure.

The particular arrangements shown in the Figures should not be viewed as limiting. It should be understood that other embodiments may include more or less of each element shown in a given Figure. Further, some of the illustrated elements may be combined or omitted. Yet further, an illustrative embodiment may include elements that are not illustrated in the Figures.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical functions or actions in the method or technique. The program code and/or related data can be stored on any type of computer readable medium such as a storage device including a disk, hard drive, or other storage medium.

The computer readable medium can also include non-transitory computer readable media such as computer-readable media that store data for short periods of time like register memory, processor cache, and random access memory (RAM). The computer readable media can also include non-transitory computer readable media that store program code and/or data for longer periods of time. Thus, the computer readable media may include secondary or persistent long term storage, like read only memory (ROM), optical or magnetic disks, compact-disc read only memory (CD-ROM), for example. The computer readable media can also be any other volatile or non-volatile storage systems. A computer readable medium can be considered a computer readable storage medium, for example, or a tangible storage device.

While various examples and embodiments have been disclosed, other examples and embodiments will be apparent to those skilled in the art. The various disclosed examples and embodiments are for purposes of illustration and are not intended to be limiting, with the true scope being indicated by the following claims.

1. A system comprising:
a plurality of cameras disposed so as to capture images of a light field; and
a controller comprising at least one processor and a memory, wherein the at least one processor executes instructions stored in the memory so as to carry out operations, the operations comprising:
causing the plurality of cameras to capture light field image data, wherein the light field image data comprises a plurality of sample data points;
determining a viewpoint position and a viewpoint pose;
determining a nearest neighbor set based on the sample data points, the viewpoint position, and the viewpoint pose;
interpolating within the nearest neighbor set so as to form a set of resampled data points; and
rendering a 360° image from the set of resampled data points, wherein the 360° image comprises a representation of the light field based on the viewpoint position and the viewpoint pose.

2. The system of claim 1, wherein the plurality of cameras is disposed on a sphere, wherein each camera of the plurality of cameras is arranged facing outwards from the sphere.

3. The system of claim 1, wherein interpolating within the nearest neighbor set comprises carrying out a linear interpolation or a polynomial interpolation.

4. The system of claim 1, wherein the operations further comprise partitioning the light field image data into a plurality of light field tiles, wherein at least one light field tile is ignored or deleted based on the viewpoint position and the viewpoint pose, wherein the light field tiles comprise light field tiles within a field of view and light field tiles outside the field of view.

5. The system of claim 4, wherein partitioning the light field image data comprises partitioning the light field image data into a plurality of four-dimensional or three-dimensional tiles.

6. The system of claim 4, wherein partitioning the light field image data comprises partitioning the light field image data based on a Fourier transform or a Wavelet transform, wherein the light field tiles comprise similar ranges of spatial frequency information.

7. The system of claim 4, further comprising a client device, wherein the operations further comprise streaming the light field tiles within the field of view to the client device.

8. The system of claim 1, further comprising a sensor, wherein determining the viewpoint position and the viewpoint pose comprises receiving, via the sensor, information indicative of at least one of: the viewpoint position or the viewpoint pose.

9. The system of claim 8, further comprising a client device, wherein the operations further comprise:
determining, based on the received sensor information, a predicted motion;
determining, based on the predicted motion, at least one predicted viewable light field tile; and
streaming the at least one predicted viewable light field tile to the client device.

10. The system of claim 9, wherein streaming the at least one predicted viewable light field tile comprises streaming a low resolution representation of the respective predicted viewable light field tile and a high resolution representation of the respective predicted viewable light field tile, wherein the operations further comprise initially presenting at least a portion of the low resolution representation to a user and when at least a threshold amount of the high resolution representation has been streamed to the client device, subsequently presenting at least a portion of the high resolution representation to the user.

11. The system of claim 9, wherein determining the at least one predicted viewable light field tile comprises determining the predicted motion is greater than a threshold amount toward a respective direction of the predicted viewable light field tile with respect to a current viewpoint position and a current viewpoint pose.

12. The system of claim 1, wherein the operations further comprise:
pre-rendering a plurality of viewable light field tiles in high resolution; and
pre-rendering at least a portion of the light field image data in low resolution.

13. The system of claim 1, wherein the plurality of sample data points has a variable sample density based at least on the viewpoint position and the viewpoint pose.

14. A method comprising:
capturing, with a plurality of cameras, light field image data from a light field, wherein the light field image data comprises a plurality of sample data points;
determining a viewpoint position and a viewpoint pose;
determining a nearest neighbor set based on the sample data points, the viewpoint position, and the viewpoint pose;
interpolating within the nearest neighbor set so as to form a set of resampled data points; and
rendering a 360° image from the set of resampled data points, wherein the 360° image comprises a representation of the light field based on the viewpoint position and the viewpoint pose.

15. The method of claim 14, further comprising interpolating within the nearest neighbor set comprises carrying out a linear interpolation or a polynomial interpolation.

16. The method of claim 14, further comprising partitioning the light field image data into a plurality of light field tiles, wherein at least one light field tile is ignored or deleted based on the viewpoint position and the viewpoint pose, wherein the light field tiles comprise viewable light field tiles and unviewable light field tiles.

17. The method of claim 16, wherein partitioning the light field image data comprises partitioning the light field image data into a plurality of four-dimensional or three-dimensional tiles.

18. The method of claim 16, wherein partitioning the light field image data comprises partitioning the light field image data based on a Fourier transform or a Wavelet transform, wherein the light field tiles comprise similar ranges of spatial frequency information.

19. The method of claim 16, further comprising streaming the viewable light field tiles to a client device.

20. The method of claim 14, wherein determining the viewpoint position and the viewpoint pose comprises receiving, via a sensor, information indicative of at least one of: the viewpoint position or the viewpoint pose, wherein the method further comprises:
determining, based on the received sensor information, a predicted motion;
determining, based on the predicted motion, at least one predicted viewable light field tile; and
streaming the at least one predicted viewable light field tile to a client device.
